(19) United States
(12) Patent Application Publication
(10) Pub. No.: US 2025/0330762 A1
(43) Pub. Date: Oct. 23, 2025

(54) GENERATION DEVICE, GENERATION METHOD, AND GENERATION PROGRAM

(71) Applicant: SONY GROUP CORPORATION, Tokyo (JP)

(72) Inventors: Toru NAKAGAWA, Tokyo (JP); Tetsu MAGARIYACHI, Tokyo (JP); Akihito NAKAI, Tokyo (JP)

(21) Appl. No.: 18/870,740

(22) PCT Filed: May 25, 2023
(86) PCT No.: PCT/JP2023/019446

§ 371 Date: Dec. 2, 2024

(30) Foreign Application Priority Data
Jun. 8, 2022 (JP) 2022-093018

(51) Int. Cl. H04S 7/00

(52) U.S. Cl. CPC H04S 7/302; H04S 2420/01

(57) ABSTRACT

A generation device according to an aspect of the present disclosure includes: an acquisition unit that acquires a first head-related transfer function characteristic of a user as a measurement target using a first measurement signal; and a generation unit that generates a second measurement signal by convolving an inverse characteristic of the first head-related transfer function characteristic acquired by the acquisition unit into a predetermined measurement signal.

### FIELD

The present disclosure relates to a generation device, a generation method, and a generation program for generating a measurement signal used to measure a head-related transfer function.

### BACKGROUND

A technique of stereoscopically reproducing a sound image in a headphone or the like using a head-related transfer function (HRTF) that mathematically represents how a sound reaches from a sound source to an ear is used.

For example, a technique capable of reproducing an acoustic space more flexibly using an acoustic parameter obtained by actual measurement and an acoustic parameter in a virtual reproduction space is known.

### CITATION LIST

### Patent Literature

Patent Literature 1: WO 2021/187229 A

### SUMMARY

### Technical Problem

According to the technique of the related art, it is possible to reproduce various acoustic spaces intended by a content creator with high accuracy.

It is known that the reproducibility of an acoustic space is further improved by accurately measuring an HRTF of each individual. However, in a general HRTF measurement system, since a spatial characteristic of a measurement location, a speaker characteristic for outputting a measurement signal, a background noise characteristic, and the like are different, measurement appropriate for each environment is not necessarily performed. A measurer can adjust an environment to obtain an appropriate measurement result, but manually adjusting an environment for every measurement requires a large work load on the measurer.

Accordingly, the present disclosure proposes a generation device, a generation method, and a generation program capable of performing optimum measurement while reducing a burden related to the measurement of an HRTF.

### Solution to Problem

In order to solve the above problems, a generation device according to one embodiment of the present disclosure includes: an acquisition unit that acquires a first head-related transfer function characteristic of a user as a measurement target using a first measurement signal; and a generation unit that generates a second measurement signal by convolving an inverse characteristic of the first head-related transfer function characteristic acquired by the acquisition unit into a predetermined measurement signal.

### BRIEF DESCRIPTION OF DRAWINGS

FIG. 1 is a diagram illustrating an overview of a generation process according to an embodiment.

FIG. 2 is a diagram (1) illustrating a measurement signal according to the embodiment.

FIG. 3 is a diagram (2) illustrating a measurement signal according to the embodiment.

FIG. 4 is a diagram (3) illustrating a measurement signal according to the embodiment.

FIG. 5 is a diagram illustrating a process of adjusting a measurement time according to the embodiment.

FIG. 6 is a diagram illustrating a user interface according to the embodiment.

FIG. 7 is a block diagram illustrating an overview of the generation process according to the embodiment.

FIG. 8 is a diagram illustrating a configuration example of a generation device according to the embodiment.

FIG. 9 is a flowchart illustrating a procedure of the generation process according to the embodiment.

FIG. 10 is a diagram illustrating a user interface according to a modification.

FIG. 11 is a diagram illustrating a hardware configuration of an example of a computer that implements functions of the generation device.

### DESCRIPTION OF EMBODIMENTS

Hereinafter, embodiments of the present disclosure will be described in detail with reference to the drawings. In each of the following embodiments, the same portions are denoted by the same reference numerals, and repeated description thereof will be omitted.

The present disclosure will be described in the following order of items.
1. Embodiment
1-1. Overview of generation process according to embodiment
1-2. Configuration of generation device according to embodiment
1-3. Procedure of generation process according to embodiment
1-4. Modification according to embodiment
1-4-1. Type of measurement signal
1-4-2. Mode of generation device
2. Other embodiments
3. Effects of generation device according to present disclosure
4. Hardware configuration

### 1. EMBODIMENT

### (1-1. Overview of Generation Process According to Embodiment)

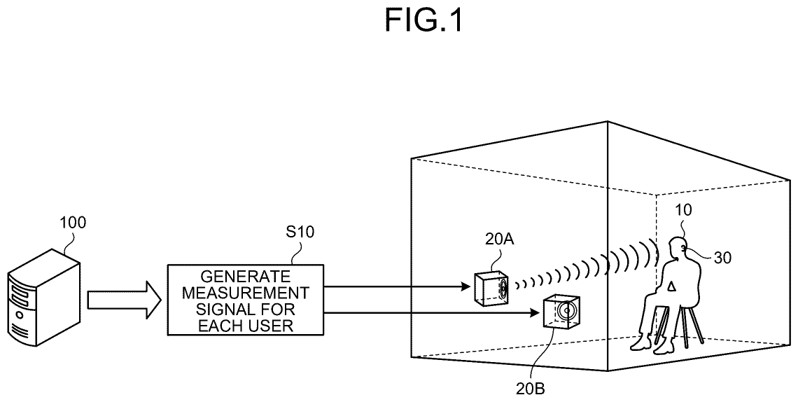

First, an overview of a generation process according to an embodiment will be described with reference to FIG. 1. FIG. 1 is a diagram illustrating an overview of the generation process according to the embodiment.

The generation process according to the embodiment is performed by a generation device 100 illustrated in FIG. 1. The generation device 100 is, for example, an information processing terminal such as a server, a personal computer (PC), or a tablet terminal. The generation device 100 generates a signal for HRTF measurement through the generation process according to the embodiment, and measures the HRTF of a user using the generated signal. The generation device 100 may output a measurement signal from the own device or may control an output of a signal in an output device that outputs the measurement signal through wired or wireless communication.

In general, the HRTF is acquired by measuring an acoustic signal for measurement using a microphone, a dummy head microphone, or the like equipped in an auricle of a subject. The acquired HRTF is used for a sound reproduction technique in, for example, a content such as game and music. Since the HRTF has a large individual difference, it is desirable to use the HRTF of the user themselves who views the content to implement a more effective acoustic production effect.

A reproduction filter of the personalized HRTF (personalized data) is implemented by convolving an inverse function of the HRTF from a headphone to an ear of the user into the HRTF from a measurement speaker to the ear. Here, the HRTF from the measurement speaker to the ear of the user can be measured by reproducing the measurement signal from the speaker at a measurement location and using a microphone inserted into the ear of the user themselves.

However, in a general HRTF measurement system, since a spatial characteristic of a measurement location, a speaker characteristic for outputting a measurement signal, a background noise characteristic, and the like are different, measurement appropriate for each environment is not necessarily performed. A measurer can adjust an environment to obtain an appropriate measurement result, but manually adjusting an environment for every measurement requires a large work load on the measurer. A frequency characteristic of the measured HRTF is not flat, but a general measurement signal has a flat frequency characteristic or a homogeneous frequency characteristic.

From the above situation, when a general measurement signal is used in the measurement of the HRTF, a problem that a signal-to-noise ratio (SN ratio) during the measurement cannot be sufficiently guaranteed depending on a frequency bandwidth or the measurement cannot be efficiently performed such that a measurement time is prolonged may occur. That is, in the measurement of the HRTF, there is a need to perform the measurement in which the SN ratio is sufficiently gained considering a spatial characteristic (a reverberation time and background noise) and the HRTF characteristic during measurement and to optimize the measurement time and efficiently perform the measurement.

Accordingly, the generation device 100 according to the present disclosure solves the above problem according to the configuration to be described below. Specifically, the generation device 100 obtains a first HRTF of a user as a measurement target using a first measurement signal (for example, a known flat measurement signal) in a preliminary measurement. Further, for subsequent actual measurement, the generation device 100 generates a second measurement signal (a measurement signal generated by the generation device 100 in the embodiment) by convolving an inverse characteristic of the acquired first HRTF into a predetermined measurement signal. That is, the second measurement signal is a measurement signal that has a non-flat frequency characteristic and an inverse characteristic of a temporary HRTF is convolved. The fact that an inverse characteristic of a temporary HRTF is convolved into a measurement signal means that a sufficient SN ratio can be earned for each frequency with respect to a head-related transfer function characteristic that will be measured in the actual measurement. As described above, the generation device 100 does not measure the HRTF using the general measurement signal, but performs the measurement in which the SN ratio is sufficiently guaranteed by generating a measurement signal for the HRTF.

An overview of the above process will be described with reference to FIG. 1. The example of FIG. 1 shows a situation in which the HRTF of a user 10 is measured using a measurement signal generated by the generation device 100. In FIG. 1, the measurement signal is output from speakers 20A and 20B (hereinafter, when it is not necessary to distinguish the speakers from each other, the speakers are collectively referred to as speakers 20) that are output devices. The user 10 equips a microphone 30 in an auricle and observes the measurement signal output from the speaker 20A or the speaker 20B. In the example of FIG. 1, only two output devices, the speakers 20A and 20B, are illustrated, but actually, the speakers 20 are installed as many as necessary for the measurement of the HRTF such that the circumference of the user 10 is surrounded.

In the embodiment, before the second measurement signal is generated, the generation device 100 pre-measures the HRTF of the user 10 (referred to as a “temporary HRTF” for distinction) using the first measurement signal (a signal that has a known flat characteristic).

Thereafter, the generation device 100 generates a measurement signal for each user by convolving the inverse characteristic of the temporary HRTF measured in the preliminary measurement into the predetermined measurement signal (for example, the first measurement signal used in the preliminary measurement) (step S10). Although details will be described below, the generation device 100 may generate the second measurement signal considering not only the inverse characteristic of the temporary HRTF but also an environmental characteristic such as background noise.

The generation device 100 measures the HRTF of the user 10 using the generated second measurement signal. For example, the generation device 100 acquires the HRTF corresponding to a direct front direction of the user 10 by outputting the second measurement signal from the speaker 20A installed directly in front of the user 10 and observing the output signal with the microphone 30. The generation device 100 acquires the HRTF corresponding to a direction of 30 degrees to the left toward the user 10 by outputting the second measurement signal from the speaker 20B installed in a direction of 30 degrees to the left toward the user 10 and observing the output signal with the microphone 30. By repeating such observation, the generation device 100 acquires the HRTF of the user 10. As described above, since the HRTF is required to output the measurement signal to the user 10 in various directions, the second measurement signal is also generated as a signal corresponding to each direction. That is, the generation device 100 generates the second measurement signal corresponding to each user and each direction by convolving the inverse characteristic of the temporary HRTF acquired corresponding to a certain direction into the measurement signal output from the certain direction.

As described above, the generation device 100 generates the measurement signal different for each user, thereby making it possible to sufficiently gain the SN ratio in the measurement of the HRTF.

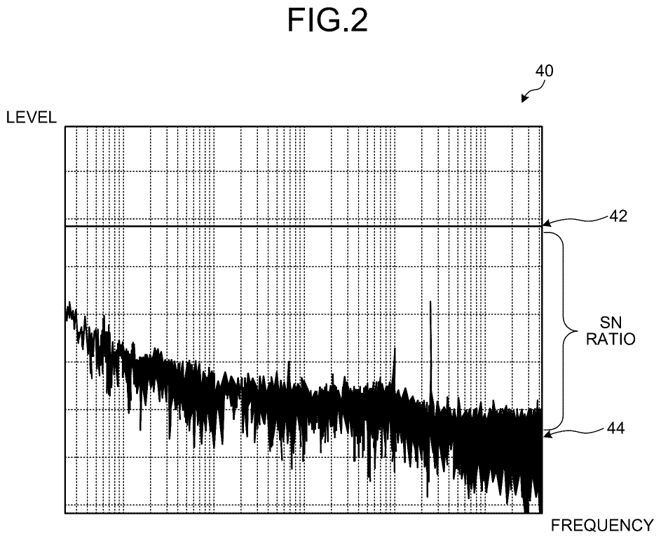

Next, the measurement signal generated by the generation device 100 will be specifically illustrated using FIG. 2 and subsequent drawings. First, in FIG. 2, a relationship between a background noise at a measurement location and a measurement signal generated by the generation device 100 will be described. FIG. 2 is a diagram (1) illustrating the measurement signal according to the embodiment.

A graph 40 illustrated in FIG. 2 shows a relationship between the first measurement signal and the background noise characteristic. The horizontal axis of the graph 40 represents a frequency and the vertical axis of the graph 40 represents a level (intensity of a signal or a sound). A first measurement signal graph 42 shows a frequency characteristic of the first measurement signal. For example, the first measurement signal is a time stretched pulse (TSP) signal generally used to measure the HRTF or the like. The TSP signal is a sweep signal that is smoothly output from a low frequency to a high frequency and is widely used for measurement of the frequency characteristic and the like.

A background noise graph 44 is a graph that shows the background noise observed at a measurement location at which the HRTF of the user 10 is to be measured. That is, it can be said that a difference between the first measurement signal graph 42 and the background noise graph illustrated in the graph 40 indicates an SN ratio. As illustrated in FIG. 2, a high level of the background noise is generally observed in a low frequency bandwidth, and a low level of the background noise is observed in a high frequency bandwidth. Therefore, even if the measurement signal is output flat, there is no problem in a high frequency bandwidth. However, since the level of the measurement signal approaches closer to the level of the background noise in the low frequency bandwidth, a sufficient SN ratio may not be obtained depending on the level of the measurement signal.

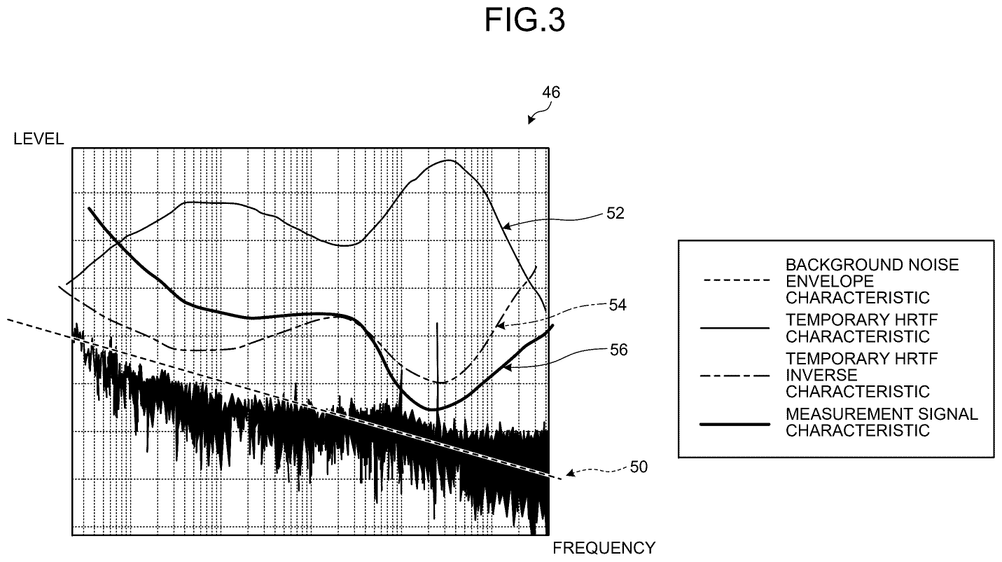

Next, the second measurement signal generated considering the temporary HRTF illustrated in FIG. 1 and the background noise illustrated in FIG. 2 will be described with reference to FIG. 3. FIG. 3 is a diagram (2) illustrating the measurement signal according to the embodiment.

As described above, the first measurement signal graph 42 illustrated in FIG. 2 shows a signal that has a flat frequency characteristic. However, it is desirable that the measurement signal used for the measurement can sufficiently ensure a level difference from the HRTF assumed to be observed in the actual measurement. Therefore, the generation device 100 performs the following process to generate the second measurement signal that is the measurement signal for the actual measurement.

First, the generation device 100 adjusts a characteristic difference between the measurement signal and the background noise to be uniform such that the level difference between the measurement signal and the background noise becomes as large as possible. Further, before an accurate HRTF of the user 10 is measured, the generation device 100 performs the preliminary measurement to obtain the temporary HRTF. The generation device 100 generates the second measurement signal by obtaining the inverse characteristic of the temporary HRTF and convolving the inverse characteristic and a background noise envelope characteristic into the first measurement signal.

A graph 46 illustrated in FIG. 3 shows the background noise envelope characteristic and the inverse characteristic of the temporary HRTF observed by the generation device 100. A background noise envelope characteristic graph 50 illustrated in FIG. 3 is obtained by linearly approximating the frequency characteristic of the background noise observed at the measurement location. A temporary HRTF characteristic graph 52 indicates the frequency characteristic of the temporary HRTF of the user 10 acquired by the preliminary measurement. A temporary HRTF inverse characteristic graph 54 shows the inverse characteristic of the temporary HRTF characteristic graph 52.

The generation device 100 generates the second measurement signal by convolving the background noise envelope characteristic and the inverse characteristic of the temporary HRTF into the first measurement signal. A measurement signal characteristic 56 illustrated in FIG. 3 is obtained by convolving the background noise envelope characteristic and the temporary HRTF characteristic into the first measurement signal. As described above, the second measurement signal generated by the generation device 100 does not have a flat frequency characteristic and has a characteristic that is assumed to have the highest SN ratio over the entire frequency when the actual measurement is performed on the HRTF of the user 10. That is, when the HRTF of the user 10 is measured in the actual measurement, the generation device 100 can generate the second measurement signal in which a characteristic difference (SN ratio) from the background noise is uniform and the SN ratio to the HRTF over the entire frequency is assumed to be sufficiently earned.

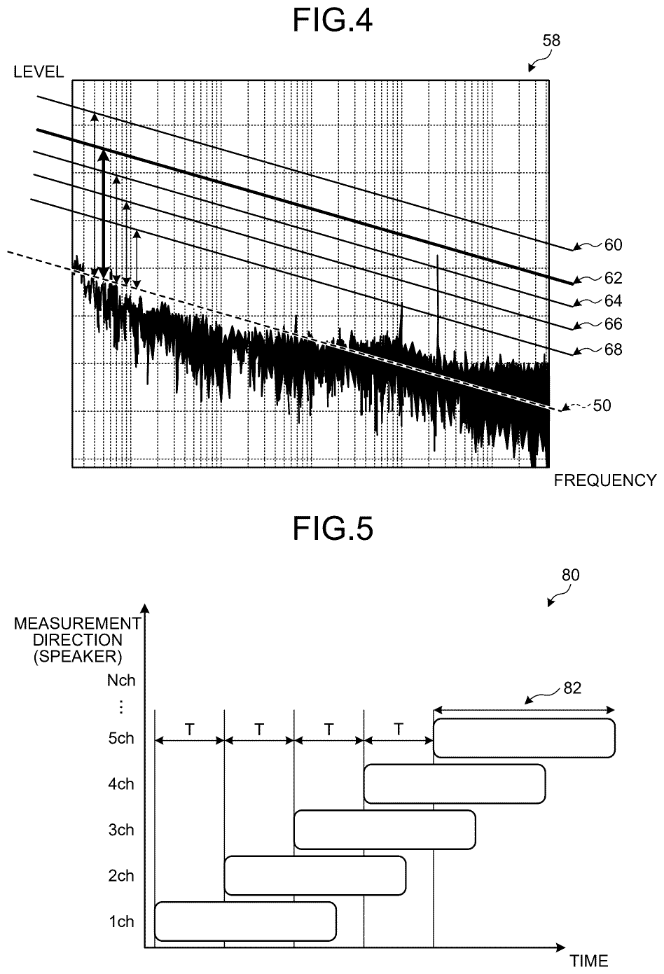

In FIG. 3, the process of optimizing the frequency characteristic of the second measurement signal is described. Next, optimization of a level of the entire second measurement signal will be described with reference to FIG. 4. FIG. 4 is a diagram (3) illustrating the measurement signal according to the embodiment.

A graph 58 illustrated in FIG. 4 exemplifies a level difference between the background noise envelope characteristic graph 50 and the measurement signal. For example, it is assumed that a level difference between a signal graph 60 and the background noise envelope characteristic graph 50 is 50 dB, a level difference between a signal graph 62 and the background noise envelope characteristic graph 50 is 40 dB, a level difference between a signal graph 64 and the background noise envelope characteristic graph 50 is 30 dB, a level difference between a signal graph 66 and the background noise envelope characteristic graph 50 is 20 dB, and a level difference between a signal graph 68 and the background noise envelope characteristic graph 50 is 10 dB.

The generation device 100 determines a level of the measurement signal based on designation by the measurer or a general appropriate value of the SN ratio. The SN ratio can be adjusted by increasing a signal length, but when the signal length is unnecessarily increased, it takes time for the measurement. Since the HRTF measurement is required to output signals from various angles while keeping the user 10 stationary, it is desirable to shorten the signal length as much as possible to quickly complete the measurement. Therefore, the generation device 100 determines a measurement signal length considering the SN ratio that the measurer wants to secure at the minimum or the SN ratio that is assumed to be required at the minimum in the measurement.

For example, when a designation indicating that the measurer wants to set the SN ratio to “40 dB” is received from the measurer, the generation device 100 adjusts the level of the generated measurement signal such that the level difference between the measurement signal and the background noise envelope characteristic graph 50 is 40 dB. Specifically, the generation device 100 adjusts the level of the measurement signal by adjusting the signal length of the measurement signal (a length of the TSP). For example, when the length of the TSP signal becomes N times, a sound pressure becomes root (square root) N times.

After the level of the signal is determined, the generation device 100 generates the second measurement signal by convolving the inverse characteristic of the temporary HRTF illustrated in FIG. 3. Accordingly, the generation device 100 can implement optimization of the measurement signal length considering the SN ratio to be secured at the minimum for optimization of the measurement time.

After one measurement signal length is determined as described above, the generation device 100 may further execute a process of adjusting the time of the entire measurement of the HRTF. This point will be described with reference to FIG. 5. FIG. 5 is a diagram illustrating a process of adjusting the measurement time according to the embodiment.

A graph 80 is a graph that conceptually shows a relationship between a signal length output from the individual speakers 20 and an entire measurement time. A signal length 82 indicates the length of each measurement signal.

As described above, considering a burden of the user 10 in measurement, it is desirable for the entire measurement time to be short. Therefore, the generation device 100 can superimpose (overlap) the signals output from the individual speakers 20 within a range in which there is no interference to the measurement. Since the measurement signal is sequentially reproduced for each frequency bandwidth, if a response time (that is, a reverberation time) of each frequency bandwidth can be secured in the measurement signal for each output destination (hereinafter referred to as a “channel”), the generation device 100 can overlap the measurement signal.

Here, the generation device 100 measures a reverberation time T in the measurement environment in the preliminary measurement. After a signal is output from a previous channel, the generation device 100 starts a signal output of a subsequent channel at a time interval of the reverberation time T. For example, as illustrated in FIG. 5, after a signal of 1 channel is output, the generation device 100 provides an interval of the reverberation time T and starts outputting a signal of 2 channel while outputting the signal of 1 channel.

As such, the generation device 100 can shorten the entire measurement time by overlapping and outputting measurement signals within a range in which there is no influence to the measurement. Accordingly, the generation device 100 can reduce the burden on the user 10 and the measurer.

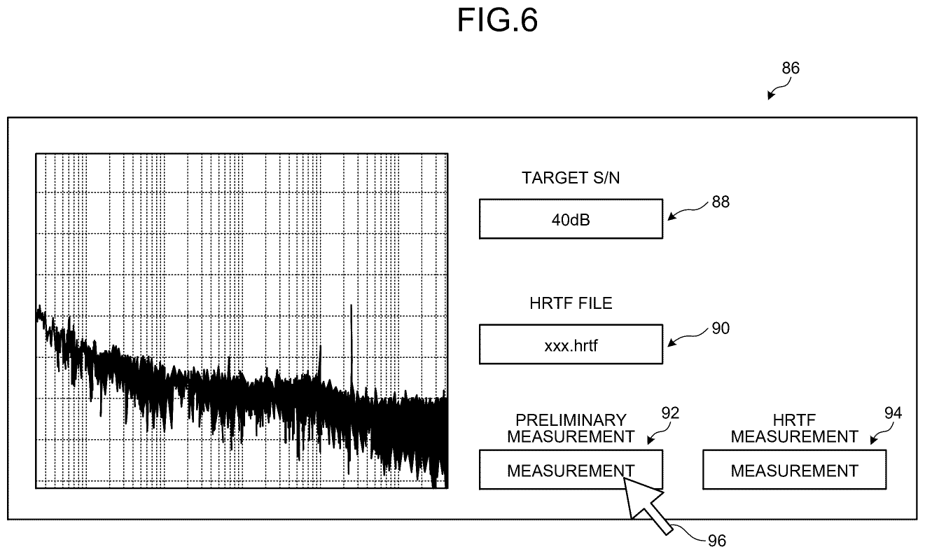

Next, an example of a user interface used for measurement will be described in FIG. 6. FIG. 6 is a diagram illustrating a user interface 86 according to the embodiment. The user interface 86 is displayed on, for example, a display or the like connected to the generation device 100.

In the HRTF measurement of the user 10, the measurer can smoothly progress the measurement by inputting a numerical value to the user interface 86 or performing an operation on the user interface 86.

For example, the measurer inputs a numerical value of the target SN ratio in a window 88. The generation device 100 determines a signal length of the second measurement signal to be generated based on the input numerical value.

When data of the temporary HRTF of the user 10 acquired in advance as data for generating the second measurement signal exists, the measurer selects the data in a window 90. When the measurer does not own the data of the temporary HRTF of the user 10 or wants to omit the preliminary measurement, the measurer may select data in which a general-purpose HRTF is stored as the temporary HRTF for generating the second measurement signal in the window 90.

When the measurer desires to perform the preliminary measurement to acquire a reverberation time and the temporary HRTF, the measurer presses a preliminary measurement button 92 with a cursor 96. Here, the generation device 100 performs the preliminary measurement using the first measurement signal or the like and acquires the reverberation time in the measurement environment and the temporary HRTF of the user 10. The generation device 100 may measure the background noise in the measurement environment before and after the measurer presses the preliminary measurement button 92 at a timing at which a signal or the like is not being output.

When the preliminary measurement ends and the actual measurement is ready, the measurer presses an actual measurement button 94 with the cursor 96. Here, the generation device 100 outputs the generated second measurement signal and performs the actual measurement on the HRTF of the user 10. The generation device 100 can quickly complete the measurement by overlapping the output of the second measurement signal based on the reverberation time T in the measurement.

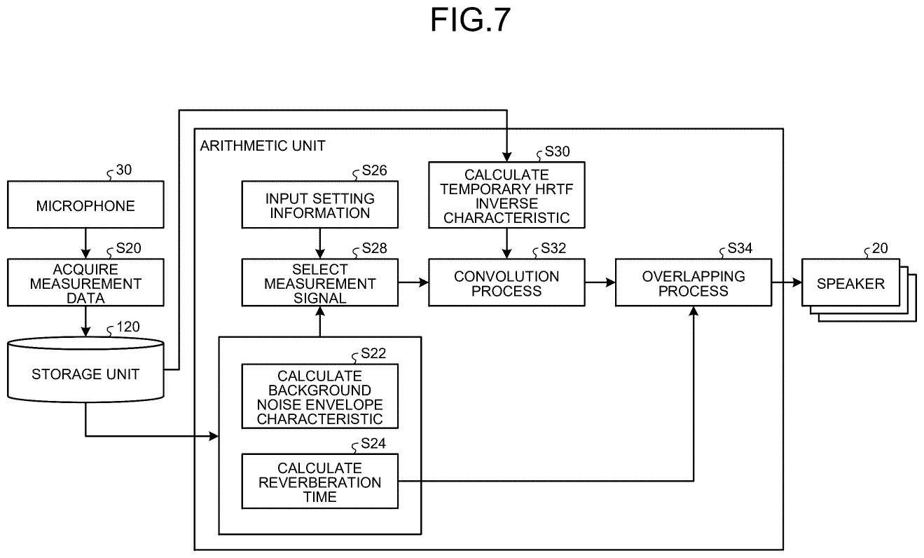

Next, an overall configuration of the generation process according to the embodiment will be described with reference to FIG. 7. FIG. 7 is a block diagram illustrating an overview of the generation process according to the embodiment.

The generation device 100 acquires measurement data from the microphone 30 equipped by the user 10 (step S20). The measurement data acquired in step S20 includes data related to the preliminary measurement, data related to the background noise measured at the measurement location, and the like. The generation device 100 stores the acquired data in a storage unit 120.

The generation device 100 calculates the background noise envelope characteristic based on the measurement data (step S22). The generation device 100 measures the reverberation time in the measurement environment based on the measurement data (step S24).

The generation device 100 receives an input of setting information from the measurer or the user 10 via the user interface (step S26). For example, the generation device 100 receives a type of a signal used as a measurement signal (whether the signal is a TSP signal or another signal, whether to sweep frequency from low frequency or high frequency, or the like) and a setting related to measurement of the target SN ratio or the like. The generation device 100 selects the measurement signal based on the received information (step S28). The generation device 100 adjusts the measurement signal based on the target SN ratio such that the frequency characteristic becomes a uniform level considering the background noise envelope characteristic.

The generation device 100 measures the temporary HRTF of the user 10 based on the data obtained by the preliminary measurement and calculates the inverse characteristic of the temporary HRTF (step S30). Then, the generation device 100 convolves the inverse characteristic of the temporary HRTF into the measurement signal selected in step S28 (step S32).

Thereafter, the generation device 100 performs a process such as setting of an overlap time of the measurement signal based on the calculated reverberation time (step S34). Then, in the actual measurement, the generation device 100 performs control such that the generated measurement signal is output from each speaker 20.

### (1-2. Configuration of Generation Device According to Embodiment)

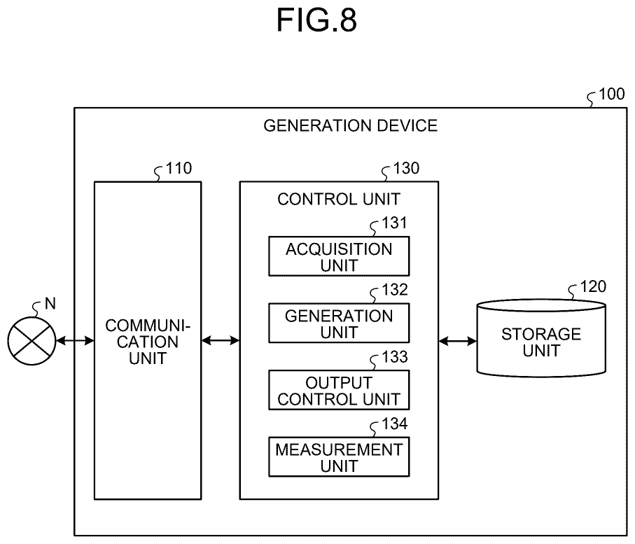

Next, a configuration of the generation device 100 according to the embodiment will be described with reference to FIG. 8. FIG. 8 is a diagram illustrating a configuration example of the generation device 100 according to the embodiment.

As illustrated in FIG. 8, the generation device 100 includes a communication unit 110, a storage unit 120, and a control unit 130. The generation device 100 may include an input unit (for example, a touch panel) that receives various operations from a user or the like who operates the generation device 100 and a display unit (for example, a liquid crystal display) that displays various types of information.

The communication unit 110 is implemented by, for example, a network interface card (NIC) or the like. The communication unit 110 is connected to a network N (Internet, near field communication (NFC), Bluetooth, or the like) in a wired or wireless manner, and transmits and receives information to and from the speaker 20, the microphone 30, and the like via the network N.

The storage unit 120 is implemented by, for example, a semiconductor memory element such as a random access memory (RAM) or a flash memory, or a storage device such as a hard disk or an optical disk.

The storage unit 120 stores various types of information related to the measurement. For example, the storage unit 120 stores the temporary HRTF data of the user 10 acquired through the temporary measurement, the background noise envelope characteristic, the reverberation time, and the like. When there is the HRTF data of the user 10 measured in advance, the storage unit 120 stores such data. The storage unit 120 stores the first measurement signal used for the preliminary measurement, the generated second measurement signal, and the like. The storage unit 120 stores the HRTF data and the like of the user 10 measured using the second measurement signal.

The control unit 130 is implemented by, for example, a central processing unit (CPU), a micro processing unit (MPU), or the like that executes a program stored in the generation device 100 (for example, a generation program according to the present disclosure) using a random access memory (RAM) or the like as a work area. The control unit 130 is a controller and may be implemented by, for example, an integrated circuit such as an application specific integrated circuit (ASIC) or a field programmable gate array (FPGA).

As illustrated in FIG. 8, the control unit 130 includes an acquisition unit 131, a generation unit 132, an output control unit 133, and a measurement unit 134, and implements or executes functions and operational effects of information processing to be described below. An internal configuration of the control unit 130 is not limited to the configuration illustrated in FIG. 8 and may be another configuration as long as information processing to be described below is performed.

The acquisition unit 131 acquires various types of information. For example, the acquisition unit 131 uses the first measurement signal to acquire the first HRTF (temporary HRTF) of the user 10 as a measurement target.

The acquisition unit 131 acquires the target SN ratio in the measurement of the HRTF of the user 10. For example, the acquisition unit 131 acquires the target SN ratio in the measurement of the HRTF of the user 10 from the measurer or the like via the user interface 86 or the like illustrated in FIG. 6. When there is no designation from the measurer or the like, the acquisition unit 131 may acquire the target SN ratio in the measurement based on a target value set freely in advance (an SN ratio to the background noise characteristic is secured as 40 dB, or the like). The generation unit 132 to be described below adjusts the level of the second measurement signal based on the SN ratio acquired by the acquisition unit 131.

The acquisition unit 131 acquires the background noise characteristic in the measurement environment. For example, during the temporary measurement, the acquisition unit 131 measures the background noise using the microphone 30 installed at the measurement location in a silent state in which no signal is output for a predetermined time, and acquires the background noise characteristic based on the measured data.

The acquisition unit 131 acquires the reverberation time in the measurement environment. For example, during the temporary measurement, the acquisition unit 131 measures the reverberation time at the measurement location using a pulse signal or the like for the reverberation time measurement and acquires the measured data.

When the temporary measurement of the HRTF of the user 10 is omitted, the acquisition unit 131 may acquire the general-purpose HRTF data in advance. Here, the generation unit 132 can use a general-purpose HRTF as the temporary HRTF when the second measurement signal is generated. Accordingly, although there is a possibility of the second measurement signal not being as accurate as the temporary HRTF of the user 10 themselves, the generation unit 132 can generate the second measurement signal according to the inverse characteristic of the HRTF while saving a time of the preliminary measurement.

The generation unit 132 generates the second measurement signal by convolving the inverse characteristic of the temporary HRTF acquired by the acquisition unit 131 into the predetermined measurement signal.

The generation unit 132 adjusts an output value (level) of the second measurement signal based on the target SN ratio acquired by the acquisition unit 131. For example, the generation unit 132 adjusts the output value of the second measurement signal by adjusting an output time of the second measurement signal. Accordingly, the generation unit 132 can generate the measurement signal in which the SN ratio is sufficiently secured regarding the measurement of the HRTF.

The generation unit 132 adjusts the output value of the second measurement signal based on the background noise characteristic acquired by the acquisition unit 131. Accordingly, the generation unit 132 can generate a measurement signal capable of securing a sufficient SN ratio regardless of the measurement environment.

Further, based on the reverberation time in the measurement environment, the generation unit 132 may adjust a time in which the second measurement signal is output. Specifically, when the second measurement signal is output from a plurality of output devices (the speakers 20) based on the reverberation time, the generation unit 132 adjusts the overlap time that is a timing at which the signals are superimposed with each other. Accordingly, since the generation unit 132 can shorten the measurement time related to the HRTF, a burden on the measurer and the user 10 can be reduced.

The output control unit 133 controls the speakers 20 to output the second measurement signals generated by the generation unit 132. As described above, the second measurement signal is generated differently for each angle corresponding to the temporary HRTF. Therefore, the output control unit 133 appropriately designates the output destination and outputs the signal such that each measurement signal is output from the speaker 20 corresponding to each measurement signal.

The measurement unit 134 measures the second HRTF of the user 10 (the HRTF in the actual measurement) based on the second measurement signal of which the output is controlled by the output control unit 133.

For example, the measurement unit 134 measures the HRTF of the user 10 based on the second measurement signal adjusted according to the SN ratio, a type of signal, and the like input to the user interface 86 illustrated in FIG. 6. Accordingly, the measurement unit 134 can measure the HRTF of the user 10 more accurately and quickly as compared with a case as in the related art in which a measurement signal having a constant frequency characteristic or an inappropriate output level is used.

### (1-3. Procedure of Generation Process According to Embodiment)

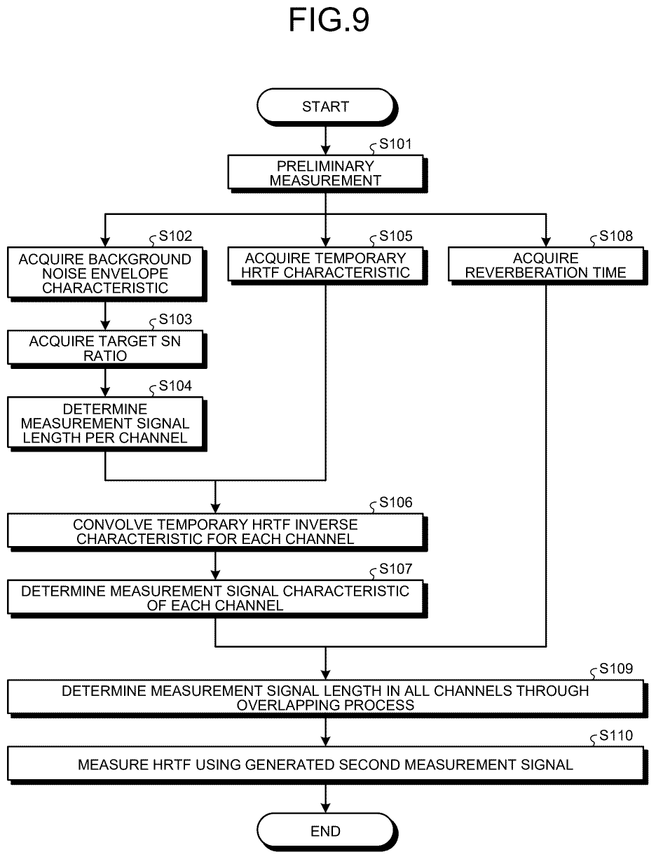

Next, a procedure of the generation process according to the embodiment will be described with reference to FIG. 9. FIG. 9 is a flowchart illustrating the procedure of the generation process according to the embodiment.

First, the generation device 100 performs the preliminary measurement in the same measurement environment as the measurement environment in which the HRTF is measured (step S101).

In the preliminary measurement, the generation device 100 measures the background noise in the measurement environment and acquires the background noise envelope characteristic (step S102). The generation device 100 acquires the target SN ratio in the measurement based on the acquired background noise envelope characteristic (step S103). For example, the generation device 100 may receive the designation of the SN ratio from the measurer or may acquire the SN ratio based on a preset recommended value.

When the SN ratio is determined, the generation device 100 calculates an output value to be set in the second measurement signal and determines a measurement signal length per channel based on the calculated value (step S104).

The generation device 100 outputs the first measurement signal in the preliminary measurement and acquires the temporary HRTF of the user 10 (step S105).

The generation device 100 convolves the inverse characteristic of the temporary HRTF obtained in step S105 for each channel into the measurement signal with the signal length determined in step S104 (step S106). Through the process, the generation device 100 can determine the measurement signal characteristic of the second measurement signal of each channel (step S107).

The generation device 100 acquires the reverberation time in the preliminary measurement (step S108). The generation device 100 determines the overlap time based on the acquired reverberation time and determines the measurement signal length in all the channels through an overlapping process (step S109).

Then, the generation device 100 measures the HRTF of the user 10 using the generated second measurement signal (step S110).

### (1-4. Modification According to Embodiment)

An information processing according to the embodiment described above may be accompanied by various modifications. Hereinafter, modifications of the embodiment will be described.

### (1-4-1. Type of Measurement Signal)

In the above embodiment, the example in which the TSP signal that outputs the sweep signal from the low frequency to the high frequency is used as the measurement signal was described. However, the measurement signal is not limited thereto, and may be freely set.

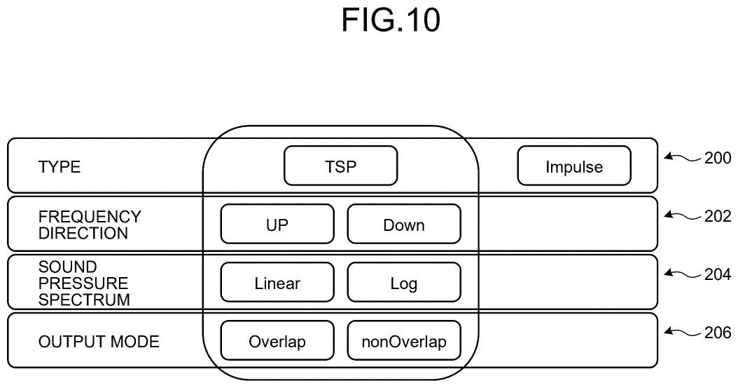

This point will be described with reference to FIG. 10. FIG. 10 is a diagram illustrating a user interface according to a modification. FIG. 10 illustrates a display example of a user interface displayed when the user 10 or the measurer selects a type of measurement signal.

For example, the measurer can select whether the measurement signal is a TSP signal or an impulse signal in a signal type selection field 200. The measurer can shorten the measurement time by selecting the impulse signal.

When the TSP signal is selected, the measurer can select whether to shift the frequency from a low frequency to a high frequency or in a reverse direction in a frequency selection field 202. The measurer can select whether to linearly set or logarithmically set a frequency bandwidth of a signal to be output in a sound pressure spectrum selection field 204. The measurer can select whether to perform measurement while overlapping the measurement signals in an output mode selection field 206.

As such, the generation device 100 can flexibly change the measurement signal according to a request of the measurer and the user 10, the measurement environment, and the measurement time.

### (1-4-2. Mode of Generation Device)

In the above embodiment, the example in which the generation device 100 receives the designation from the measurer via the user interface to generate the second measurement signal and measure the HRTF has been described.

However, the generation process according to the embodiment may not be necessarily executed by the generation device 100. For example, the generation process according to the embodiment may be a process executed by the generation program according to the present disclosure. Here, the measurer can execute the generation process according to the embodiment by installing the generation program in a general-purpose computer or the like and executing the installed generation program. That is, the generation process according to the embodiment may have modes of measurement applications executed by various information processing devices.

### 2. OTHER EMBODIMENTS

The process according to each embodiment described above may be performed in various different forms other than each embodiment described above.

In the processes described in the above embodiments, some or all of the processes described as being performed automatically can be performed manually, or some or all of the processes described as being performed manually can be performed automatically by a known method. In addition, processing procedures, specific names, and information including various types of data and parameters illustrated in the literature and the drawings can be freely changed unless otherwise mentioned. For example, various types of information illustrated in each figure are not limited to the illustrated information.

Each component of each device illustrated in the drawings is functionally conceptual, and is not necessarily physically configured as illustrated in the drawings. That is, specific forms of distributions and integrations of the devices are not limited to the illustrated form, and some or all of the configurations can be functionally or physically distributed and integrated in a freely selected unit according to various loads, usage conditions, and the like.

The above-described embodiments and modifications can be appropriately combined within a range in which the processing content does not contradict each other.

The effects described in the present specification are merely exemplary and are not limited, and other effects may be provided.

### 3. EFFECTS OF GENERATION DEVICE ACCORDING TO PRESENT DISCLOSURE

As described above, a generation device (the generation device 100 in the embodiment) according to the present disclosure includes an acquisition unit (the acquisition unit 131 in the embodiment) and a generation unit (the generation unit 132 in the embodiment). The acquisition unit acquires a first head-related transfer function characteristic (temporary HRTF) of a user as a measurement target using a first measurement signal. The generation unit generates a second measurement signal by convolving an inverse characteristic of the first head-related transfer function characteristic acquired by the acquisition unit into a predetermined measurement signal.

As such, the generation device according to the present disclosure generates a measurement signal for each individual who measures the HRTF, and thus reduces labor of the measurer manually adjusting a measurement environment and improves accuracy of the HRTF measurement. That is, the generation device can perform optimum measurement while reducing the burden related to the measurement of the HRTF.

The acquisition unit acquires a target signal-to-noise ratio (SN ratio) in the measurement of the head-related transfer function of the user. The generation unit adjusts an output value of the second measurement signal based on the target SN ratio. Specifically, the generation unit adjusts the output value of the second measurement signal by adjusting an output time of the second measurement signal.

As such, the generation device can generate the measurement signal with which appropriate data can be measured by acquiring the target SN ratio from the measurer or the like and adjusting the output value of the measurement signal according to the target SN ratio in advance.

The acquisition unit acquires a background noise characteristic in the measurement environment. The generation unit adjusts the output value of the second measurement signal based on the background noise characteristic.

As such, the generation device can generate the measurement signal considering the measurement environment by adjusting the output value of the measurement signal based on the background noise.

The acquisition unit acquires a reverberation time in the measurement environment. Based on the reverberation time, the generation unit adjusts a time in which the second measurement signal is output. For example, based on the reverberation time, the generation unit adjusts an overlap time that is a timing at which signals are superimposed each other when the second measurement signal is output from a plurality of output devices (the speakers 20 in the embodiment).

As such, since the generation device shortens the measurement time by performing an overlapping process on the measurement signal based on the reverberation time, it is possible to reduce the burden related to the measurement of the measurer or the user.

The generation device further includes an output control unit (the output control unit 133 in the embodiment) that performs control such that the second measurement signal is output from the output device, and a measurement unit (the measurement unit 134 in the embodiment) that measures a second head-related transfer function characteristic of the user based on the second measurement signal of which an output is controlled by the output control unit.

As such, the generation device can accurately measure the individual HRTF by measuring the HRTF using the generated second measurement signal.

The acquisition unit acquires the target SN ratio in the measurement of the second head-related transfer function of the user via a user interface. The generation unit adjusts the output value of the second measurement signal based on the target SN ratio. The measurement unit measures the second head-related transfer function characteristic of the user using the second measurement signal adjusted by the generation unit.

As such, the generation device can provide an environment in which the measurer or the user can easily perform the measurement by providing the user interface and performing the measurement. Accordingly, the generation device can further reduce the burden related to the measurement.

The acquisition unit acquires the head-related transfer function characteristic of the user measured using the first measurement signal or a general-purpose head-related transfer function characteristic as the first head-related transfer function characteristic.

As such, the generation device may generate the measurement signal using general-purpose HRTF data. Accordingly, since the generation device can save time and effort for preliminary measurement, the measurement can be completed more quickly.

### 4. HARDWARE CONFIGURATION

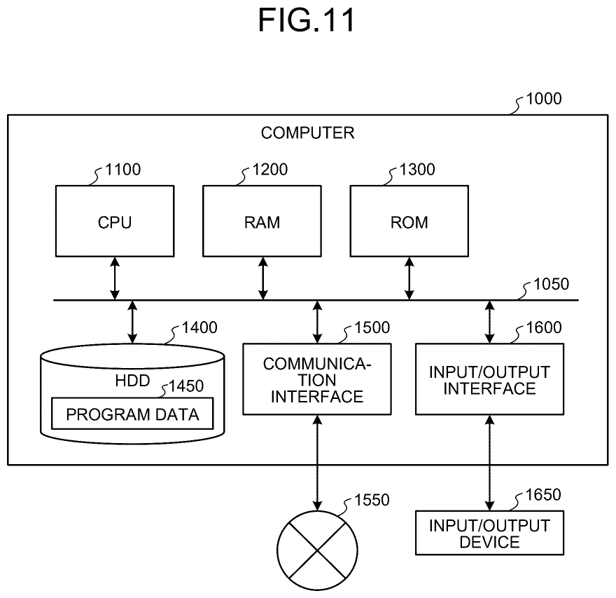

An information device such as the generation device 100 according to each of the above-described embodiments is implemented by a computer 1000 that has, for example, a configuration illustrated in FIG. 11. Hereinafter, the generation device 100 according to the embodiment will be described as an example. FIG. 11 is a diagram illustrating a hardware configuration of an example of the computer 1000 that implements the function of the generation device 100. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates based on a program stored in the ROM 1300 or the HDD 1400 and controls each unit. For example, the CPU 1100 loads programs stored in the ROM 1300 or the HDD 1400 on the RAM 1200 and executes processes corresponding to various programs.

The ROM 1300 stores a boot program such as a basic input output system (BIOS) executed by the CPU 1100 when the computer 1000 starts, a program that depends on hardware of the computer 1000, and the like.

The HDD 1400 is a computer-readable recording medium that non-transiently records a program executed by the CPU 1100, data used by the program, and the like. Specifically, the HDD 1400 is a recording medium that records a generation program according to the present disclosure that is an example of program data 1450.

The communication interface 1500 is an interface by which the computer 1000 is connected to an external network 1550 (for example, the Internet). For example, the CPU 1100 receives data from another device or transmits data generated by the CPU 1100 to another device via the communication interface 1500. The input/output interface 1600 is an interface by which an input/output device 1650 is connected to the computer 1000. For example, the CPU 1100 receives data from an input device such as a keyboard and a mouse via the input/output interface 1600. The CPU 1100 transmits data to an output device such as a display, a speaker, or a printer via the input/output interface 1600. The input/output interface 1600 may function as a medium interface that reads a program or the like recorded in a predetermined recording medium. The medium is, for example, an optical recording medium such as a digital versatile disc (DVD) or a phase change rewritable disk (PD), a magneto-optical recording medium such as a magneto-optical disc (MO), a tape medium, a magnetic recording medium, a semiconductor memory, or the like.

For example, when the computer 1000 functions as the generation device 100 according to the embodiment, the CPU 1100 of the computer 1000 implements the functions of the control unit 130 or the like by executing the generation program loaded on the RAM 1200. The HDD 1400 stores the generation program according to the present disclosure and the data in the storage unit 120. The CPU 1100 reads the program data 1450 from the HDD 1400 and executes the program data, or as another example, the program may be acquired from another device via the external network 1550.

The present technique can also have the following configurations.
(1) A generation device comprising:
   an acquisition unit that acquires a first head-related transfer function characteristic of a user as a measurement target using a first measurement signal; and
   a generation unit that generates a second measurement signal by convolving an inverse characteristic of the first head-related transfer function characteristic acquired by the acquisition unit into a predetermined measurement signal.
(2) The generation device according to (1), wherein
   the acquisition unit
   acquires a target signal-to-noise ratio (SN ratio) in measurement of a head-related transfer function of the user, and
   the generation unit
   adjusts an output value of the second measurement signal based on the target SN ratio.
(3) The generation device according to (2), wherein
   the generation unit
   adjusts an output value of the second measurement signal by adjusting an output time of the second measurement signal.
(4) The generation device according to any one of (1) to (3), wherein
   the acquisition unit
   acquires a background noise characteristic in a measurement environment, and
   the generation unit
   adjusts an output value of the second measurement signal based on the background noise characteristic.
(5) The generation device according to any one of (1) to (4), wherein
   the acquisition unit
   acquires a reverberation time in a measurement environment, and
   the generation unit
   adjusts a time in which the second measurement signal is output based on the reverberation time.
(6) The generation device according to (5), wherein
   the generation unit
   adjusts an overlap time based on the reverberation time, the overlap time being a timing at which signals are superimposed each other when the second measurement signal is output from a plurality of output devices.
(7) The generation device according to any one of (1) to (6), further comprising:
   an output control unit that performs control such that the second measurement signal is output from an output device; and
   a measurement unit that measures a second head-related transfer function characteristic of the user based on the second measurement signal of which an output is controlled by the output control unit.
(8) The generation device according to (7), wherein
   the acquisition unit
   acquires a target SN ratio in measurement of a second head-related transfer function of the user via a user interface,
   the generation unit
   adjusts an output value of the second measurement signal based on the target SN ratio, and
   the measurement unit
   measures the second head-related transfer function characteristic of the user using the second measurement signal adjusted by the generation unit.
(9) The generation device according to any one of (1) to (8), wherein
   the acquisition unit
   acquires a head-related transfer function characteristic of the user measured using the first measurement signal or a general-purpose head-related transfer function characteristic as the first head-related transfer function characteristic.
(10) A generation method comprising:
   acquiring, by a computer, a first head-related transfer function characteristic of a user as a measurement target using a first measurement signal; and
   generating, by the computer, a second measurement signal by convolving an inverse characteristic of the first head-related transfer function characteristic that is acquired into a predetermined measurement signal.
(11) A generation program causing a computer to function as:
   an acquisition unit that acquires a first head-related transfer function characteristic of a user as a measurement target using a first measurement signal; and
   a generation unit that generates a second measurement signal by convolving an inverse characteristic of the first head-related transfer function characteristic acquired by the acquisition unit into a predetermined measurement signal.

### REFERENCE SIGNS LIST

10 USER
20 SPEAKER
30 MICROPHONE
100 GENERATION DEVICE
110 COMMUNICATION UNIT
120 STORAGE UNIT
130 CONTROL UNIT
131 ACQUISITION UNIT
132 GENERATION UNIT
133 OUTPUT CONTROL UNIT
134 MEASUREMENT UNIT

What is claimed is:

1. A generation device comprising:
an acquisition unit that acquires a first head-related transfer function characteristic of a user as a measurement target using a first measurement signal; and
a generation unit that generates a second measurement signal by convolving an inverse characteristic of the first head-related transfer function characteristic acquired by the acquisition unit into a predetermined measurement signal.

2. The generation device according to claim 1, wherein
the acquisition unit
acquires a target signal-to-noise ratio (SN ratio) in measurement of a head-related transfer function of the user, and
the generation unit
adjusts an output value of the second measurement signal based on the target SN ratio.

3. The generation device according to claim 2, wherein
the generation unit
adjusts an output value of the second measurement signal by adjusting an output time of the second measurement signal.

4. The generation device according to claim 1, wherein
the acquisition unit
acquires a background noise characteristic in a measurement environment, and
the generation unit
adjusts an output value of the second measurement signal based on the background noise characteristic.

5. The generation device according to claim 1, wherein
the acquisition unit
acquires a reverberation time in a measurement environment, and
the generation unit adjusts a time in which the second measurement signal is output based on the reverberation time.

6. The generation device according to claim 5, wherein
the generation unit
adjusts an overlap time based on the reverberation time, the overlap time being a timing at which signals are superimposed each other when the second measurement signal is output from a plurality of output devices.

7. The generation device according to claim 1, further comprising:
an output control unit that performs control such that the second measurement signal is output from an output device; and
a measurement unit that measures a second head-related transfer function characteristic of the user based on the second measurement signal of which an output is controlled by the output control unit.

8. The generation device according to claim 7, wherein
the acquisition unit
acquires a target SN ratio in measurement of a second head-related transfer function of the user via a user interface,
the generation unit
adjusts an output value of the second measurement signal based on the target SN ratio, and
the measurement unit
measures the second head-related transfer function characteristic of the user using the second measurement signal adjusted by the generation unit.

9. The generation device according to claim 1, wherein
the acquisition unit
acquires a head-related transfer function characteristic of the user measured using the first measurement signal or a general-purpose head-related transfer function characteristic as the first head-related transfer function characteristic.

10. A generation method comprising:
acquiring, by a computer, a first head-related transfer function characteristic of a user as a measurement target using a first measurement signal; and
generating, by the computer, a second measurement signal by convolving an inverse characteristic of the first head-related transfer function characteristic that is acquired into a predetermined measurement signal.

11. A generation program causing a computer to function as:
an acquisition unit that acquires a first head-related transfer function characteristic of a user as a measurement target using a first measurement signal; and
a generation unit that generates a second measurement signal by convolving an inverse characteristic of the first head-related transfer function characteristic acquired by the acquisition unit into a predetermined measurement signal.
